(19) United States
(12) Patent Application Publication
(10) Pub. No.: US 2026/0279690 A1
(43) Pub. Date: Sep. 17, 2026

(54) HYBRID POLYMER WET ELECTROLYTIC TANTALUM CAPACITORS

(71) Applicant: Dr. Tantalum, LLC, Miami, FL (US)

(72) Inventor: Yuri Freeman, Miami, FL (US)

(73) Assignee: Dr. Tantalum, LLC, Miami, FL (US)

(21) Appl. No.: 19/562,969

(22) Filed: Mar. 11, 2026

Related U.S. Application Data
(60) Provisional application No. 63/771,891, filed on Mar. 14, 2025.
(60) Provisional application No. 63/858,423, filed on Aug. 6, 2025.
(60) Provisional application No. 63/965,576, filed on Jan. 22, 2026.

(51) Int. Cl. H01G 9/042; H01G 9/00; H01G 9/035; H01G 9/052; H01G 9/145

(52) U.S. Cl. CPC H01G 9/0525; H01G 9/0029; H01G 9/025; H01G 9/035

(57) ABSTRACT

A Hybrid Polymer-Wet Tantalum capacitor is disclosed, as well as a method of making the Hybrid Polymer-Wet Ta capacitor. Additionally, an anode/dielectric/conductive polymer component (unit) and method of making is also disclosed. The capacitors provide the advantages of prior Polymer Tantalum capacitors as well as prior Wet Tantalum capacitors, without the prior disadvantages of each. The inventive capacitors exhibit higher voltage, lower dc leakage and higher charge and energy efficiency in comparison to Polymer Tantalum capacitors; and lower ESR, higher ripple current and higher capacitance stability over temperature and frequency in comparison to Wet Tantalum capacitors.

### CROSS-REFERENCE TO RELATED APPLICATIONS

This application claims the benefit of U.S. Provisional Application No. 63/771,891, filed Mar. 14, 2025; U.S. Provisional Application No. 63/858,423, filed Aug. 6, 2025; and U.S. Provisional Application No. 63/965,576, filed Jan. 22, 2026; the contents of all of which are incorporated herein by reference.

### FIELD OF TECHNOLOGY

The present invention relates to Hybrid Polymer-Wet Tantalum capacitors which possess enhanced properties which are not present in either Polymer or Wet Electrolytic \Tantalum capacitors.

### BACKGROUND OF RELATED TECHNOLOGY

It has been previously impractical to combine conductive polymer and liquid electrolyte in tantalum capacitors due to low working voltages in Polymer Tantalum capacitors, coupled with the fact that Wet Electrolytic Tantalum capacitors predominantly operate at higher voltage ranges. Prior to the present invention, there was no clear or practical method of combining the best properties of these two technologies. By way of introduction, brief descriptions of the prior art Wet Tantalum and Polymer Tantalum capacitators are provided below.

### Prior Art Wet Tantalum Capacitors

In FIGS. 1A-1C, like numbers refer to the same components. Referring to prior art FIGS. 1A-1C, Wet Electrolytic Tantalum capacitors are typically made of the following components and configured as shown in FIG. 1A: A Ta anode 1 is sintered in a vacuum using pressed Ta particles and Ta wire pressed-in or welded to the anode, which continues and is connected to a positive termination 7. A Ta oxide (Ta2O5) dielectric 2 is electrochemically formed on the surface of the Ta anode particles. The thickness of the tantalum oxide dielectric is directly proportional to the formation voltage. The capacitor includes a liquid electrolyte 3 comprising a diluted aqueous sulfuric acid solution, aqueous boric acid solution or an organic liquid such as polyethylene glycol (PEG). The cathode 4 is connected to the metal housing and made of a thin sleeve of sintered fine Ta powder or can comprise ruthenium oxide (RnO2). Plastic holders or cloth separators 5 serve to insulate and cap the Ta anode with the dielectric at each end of its housing. The capacitor's housing 6 comprises a hermetic can (container) made of tantalum or a metal alloy, such as brass with a glass insulator. Terminals 7 and 8 respectively, comprise a positive termination welded to the Ta wire and a negative termination welded to the metal can 6.

With respect to the prior art Wet Electrolytic Ta capacitors at normal polarity (i.e., positive termination at the Ta anode), the liquid electrolyte replenishes oxygen in the oxide dielectric, thereby maintaining its stoichiometric composition. Additionally, at normal polarity, liquid electrolyte flows out of the micropores in the dielectric due to the electro-osmotic effect, preventing shortage of the capacitor, which provides “self-healing” properties to these capacitors. These self-healing properties allow Wet Ta capacitors to provide low direct current (DC) leakage (DCL) and high breakdown voltage (BDV), working voltage, and surge voltage. Additionally, Wet Ta capacitors allow for a lower ratio between the formation voltage and the rated voltage, typically in the range 1.5-2 V/V, and thus have the advantages of a thinner dielectric, higher charge efficiency (capacitance*DC voltage/volume in cubic centimeters or CV/cc), smaller anode size, and lower cost. On the other hand, liquid electrolytes have a relatively low conductivity due to the low mobility of the charged liquid molecules, especially at lower temperatures. As a result, Wet Ta capacitors have high equivalent series resistance (ESR), low ripple current, and rapid capacitance loss at low temperature and high frequency. Resistance of the liquid electrolyte in tiny pores in sintered Ta anodes is major contributor to the high ESR in Wet Ta capacitors.

### Prior Art Polymer Tantalum Capacitors

In FIGS. 2A-2C, like numbers refer to the same components. Referring to FIGS. 2A-2C, Polymer Tantalum capacitors include the following components: A Ta anode sintered in a vacuum with pressed tantalum particles and having a Ta wire pressed-in or welded to the anode 9 and connected to a positive termination 15. A Ta oxide (Ta2O5) dielectric coating 10 is electrochemically formed on the surface of the porous Ta anode formed from the Ta particles sintered together. Typically, the ratio between the formation voltage and the rated voltage in Polymer Ta capacitors is in the range 2.5-3.5 V/V. A conductive polymer covering 11 is placed over the oxide dielectric surface, throughout the porous Ta anode. A coating of carbon and silver 12 is applied as shown in FIG. 2A, and the silver coating is connected to the metal can 14 using solder 13. In non-hermetic capacitors, the components may be encapsulated with a non-conductive, insulating material such as an epoxy compound, and in hermetic capacitors the components may be sealed in metal can 14 with a glass insulator or a ceramic casing. As mentioned above, the Ta wire connected to the Ta anode extends from inside the capacitor housing to a positive termination 15. At an opposing end of the capacitor, a negative termination 16 is connected to either the silver layer or welded to the metal can 14.

Polymer Tantalum capacitors with intrinsically conductive polymers have been widely used in the electronics industry due to their advantageous low equivalent series resistance (ESR) and related high ripple current and capacitance stability in broad range of temperatures and frequencies. Intrinsically conductive polymer, more commonly known as conductive polymer, is electrically conductive in the molecular level. In other words, a single molecule (e.g. a polymer chain) of this type of polymer is conductive, which distinguishes itself from other groups of polymeric materials whose electrical conductivity is imported from the presence of foreign conductive particles. An example of the latter is polyester (non-conductive) filled with carbon black (conductive particles). The backbone of a conductive polymer contains a conjugated bonding structure.

Polymers used in Ta Capacitors can exist in two general states, an undoped, low-conductivity state; and a doped, high conductivity state. When doped, the polymer incorporates anionic moieties as constituents on its positively charged backbone. To achieve high conductivity, the polymers used in Ta capacitors are in doped form. Various types of intrinsically conductive polymers, which also incorporate doping materials, include, for example, poly(3,4-ethyldioxythiophene), polypyrrole, polyaniline, and polythiophene are described for use in Ta capacitors.

A major drawback of Polymer Ta capacitors, regardless of the types of conductive polymer employed, is their relatively low working voltage compared to the other types of Ta capacitors, i.e., Wet Electrolytic Ta capacitors with liquid electrolyte and Solid Electrolytic Ta capacitors with MnO2 over the dielectric. The working voltages of Polymer Ta capacitors have been initially limited to about 35 V, while the working voltages of Solid Electrolytic Tantalum capacitors available on the market can reach about 75 V; and the working voltage of Wet Electrolytic Ta capacitors can reach about 150 V. This low working voltage limitation has made applications of Polymer Ta capacitors in high voltage circuits impossible, which is where the combination of low ESR and high ripple current are most critical.

Hybrid Polymer-Wet Aluminum capacitors are available on the market and sold by Panasonic and Nichicon. Until the present invention, however, the low working voltage limitation of Polymer Ta capacitors made Hybrid Polymer-Wet Tantalum capacitors impractical.

Advances in Polymer Ta capacitors were described in Y. Freeman, Tantalum and Niobium-based Capacitors, the Second Edition, Springer, 2022. This book showed that a radical increase in breakdown voltage and thus working voltage of Polymer Ta capacitors was achieved due to slurry-type pre-polymerized conductive polymers being combined with low oxygen and carbon content in Ta anodes. The subject matter of Y. Freeman, Tantalum and Niobium-based Capacitors, the Second Edition, Springer, 2022, is incorporated by reference herein.

The manufacturing of Ta anodes is an important part of Ta capacitors technology, past and present. During manufacturing of the Ta anode, Ta powder is mechanically pressed to make Ta metal pellets. The pellets are subsequently sintered at high temperature under vacuum. The sintered anodes are then anodized in a liquid electrolyte typically at elevated temperature to form a cohesive dielectric layer (Ta2O5) on the anode surface. Increasing formation voltage increases the dielectric thickness, which is a factor in determining the maximum voltage the anodes can withstand.

Originally, conductive polymer was applied to tantalum capacitors by synthesis from the monomer and an oxidizing agent. This is known as in-situ polymerization. Typically, the polymer cathodes are prepared by the steps of dipping in oxidizing agent, drying, dipping in monomer, reacting the monomer and oxidizing agent to form a conductive polymer, and washing off by-products, not necessarily in this order. Optionally, a reformation step was applied after washing to reduce DC leakage of the finished capacitors. However, a disadvantage of in-situ polymerization is that it is extremely difficult, if not impossible, to completely remove the by-products, such as iron from the oxidizer, from the porous Ta anodes by washing after in-situ polymerization.

As the technology advanced, a slurry-type of conductive polymers was introduced to Polymer Ta capacitors. This slurry material includes a suspension of conductive polymer particles in water or a solvent. Instead of using the in-situ method of applying the conductive polymer by synthesis from the monomer and an oxidizing agent, the polymer slurry was applied by dipping in the slurry and removing the water or solvent. The slurry-type of conductive polymers do not have the deleterious effects of by-products from chemical reactions, such as those that occur when using in-situ polymer cathode processes.

It is known in the art, that reducing the oxygen and carbon content of the Ta anodes leads to the formation of a better-quality dielectric by removing the crystalline inclusions in the amorphous matrix of the dielectric that form on anode surface enriched with oxygen or carbon. These inclusions continue to grow during the field application causing dc leakage current increase and eventually catastrophic failure of Ta capacitor [see Y. Freeman, Tantalum and Niobium-Based Capacitors, the Second Edition, Springer, 2022]. It has been demonstrated on Wet and Solid Electrolytic Ta capacitors that reduction of oxygen and carbon contents in the Ta anode can significantly improve the long-term stability and reliability of these capacitors. However, little improvement was noted in the performance of Polymer Ta capacitors with reduced oxygen and carbon contents in Ta anode and in-situ polymer cathodes. At the same time, radical increase in BDV and thus working voltage and surge voltage of Polymer Tantalum capacitors were achieved when low oxygen and carbon contents in Ta anode were combined with slurry-polymer cathode (FIG. 3). Under these conditions, a potential barrier at the dielectric-polymer interface increases with voltage at normal polarity (plus on Ta anode), suppressing DCL and increasing BDV. See Y. Freeman, Tantalum and Niobium-Based Capacitors, the Second Edition, Springer, 2022.

### SUMMARY OF THE INVENTION

The invention relates to Hybrid Polymer-Wet tantalum (Ta) capacitors which have lower equivalent series resistance (ESR), and higher ripple current capability and capacitance stability over a range of frequency and temperature, as compared to Wet Electrolytic tantalum capacitors. Moreover, the advantages of Hybrid Polymer-Wet Ta capacitors over Polymer tantalum capacitors include higher breakdown voltage (BDV), working voltage and surge voltage, low and stable dc leakage. Thus, the inventive hybrid capacitors take advantage of the benefits of the prior art capacitors, while minimizing the prior art disadvantages.

The present inventive Hybrid Polymer-Wet Tantalum capacitors allow for higher breakdown voltages (BDV), higher working voltage and surge voltage, low and stable DC leakage, higher charge and increased energy efficiency, smaller anode size, and lower cost as compared to Polymer Ta capacitors. These advantages and benefits are present in the inventive Hybrid Polymer-Wet Ta capacitors, while at the same time providing lower ESR, and higher ripple current and capacitance stability over temperature and frequency in comparison to Wet Ta capacitors.

### SUMMARY OF THE FIGURES

Like numbers on the drawing refer to like elements in each of the figures.

FIGS. 1A and 1B each show schematics of a conventional prior art Wet Tantalum capacitor.

FIG. 1C is a photographic cross section of a conventional prior art Wet Tantalum capacitor.

FIGS. 2A and 2B show the schematic of a conventional prior art Hermetic Polymer Tantalum capacitor.

FIG. 2C is a photographic cross section of a conventional prior art Hermetic Polymer Tantalum capacitor.

FIG. 3 demonstrates a plot of the Breakdown voltage (BDV) versus the Formation Voltage for Ta capacitors with reduced oxygen and carbon contents in Ta anodes and different counter electrodes, including the liquid electrolyte (Wet), MnO2, or conductive polymer such as polyethyldioxythiophene (PEDOT) (Poly) obtained by either in-situ or slurry processes.

FIGS. 4A and 4B show schematics of the inventive hybrid Polymer-Wet Tantalum capacitor.

FIG. 5 demonstrates ESR vs. temperature and frequency in Wet and Hybrid Polymer-Wet Tantalum capacitors 82 uF, 75 V.

FIG. 6 demonstrates Capacitance vs. temperature and frequency in Wet and Hybrid Polymer-Wet Tantalum capacitors 82 uF, 75V.

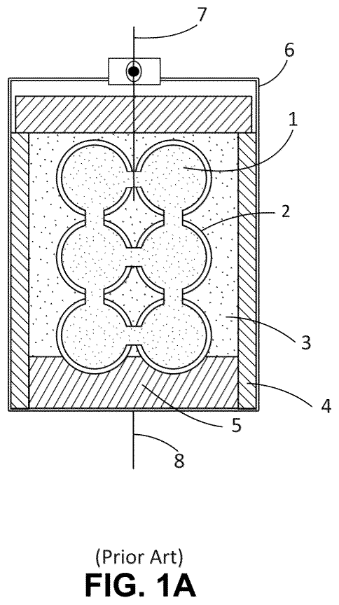

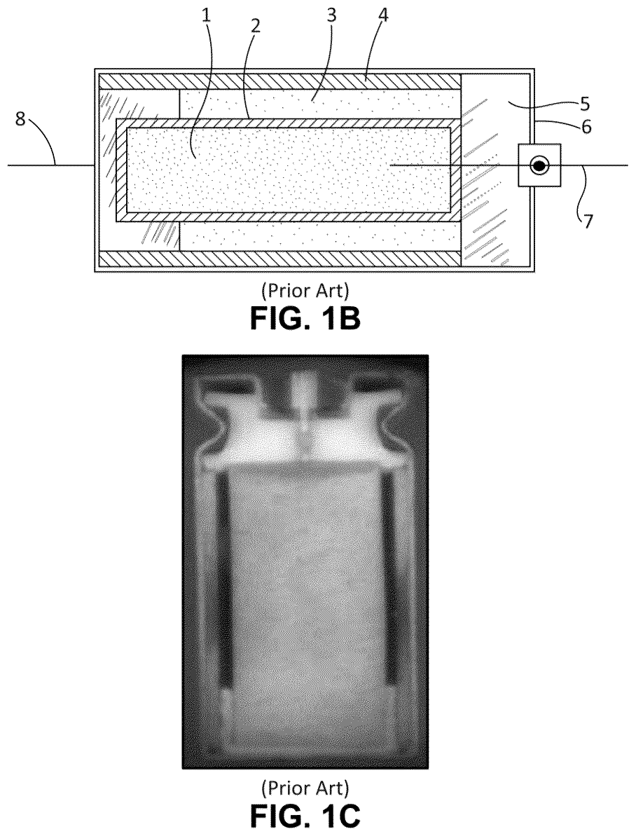

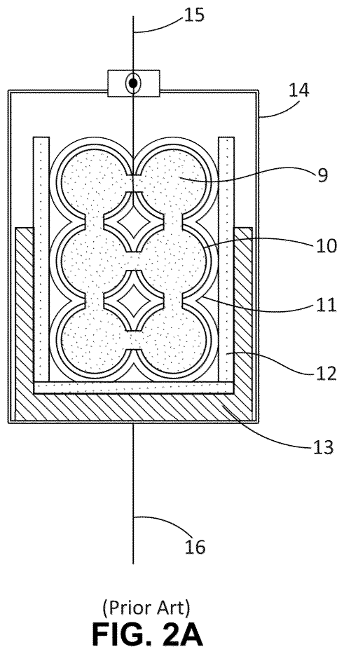

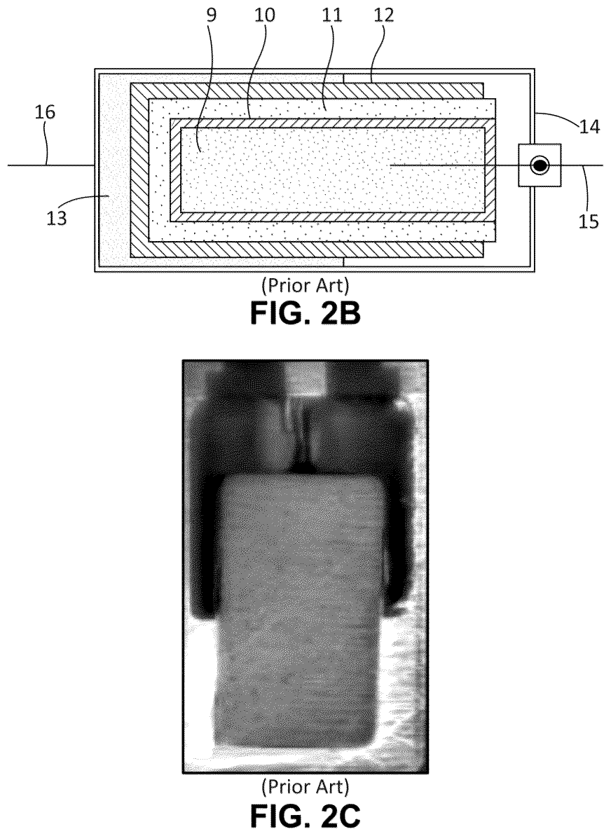

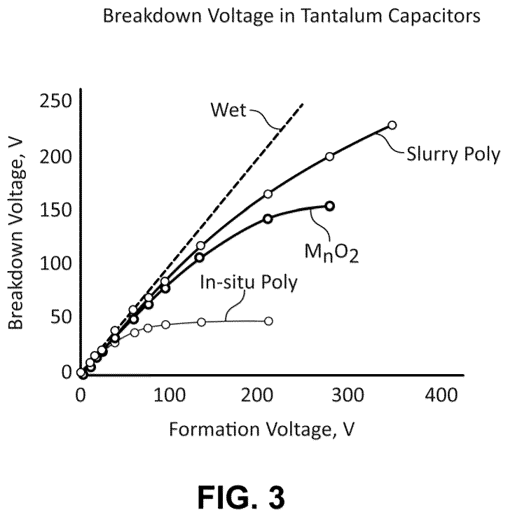

### DETAILED DESCRIPTION OF THE INVENTION

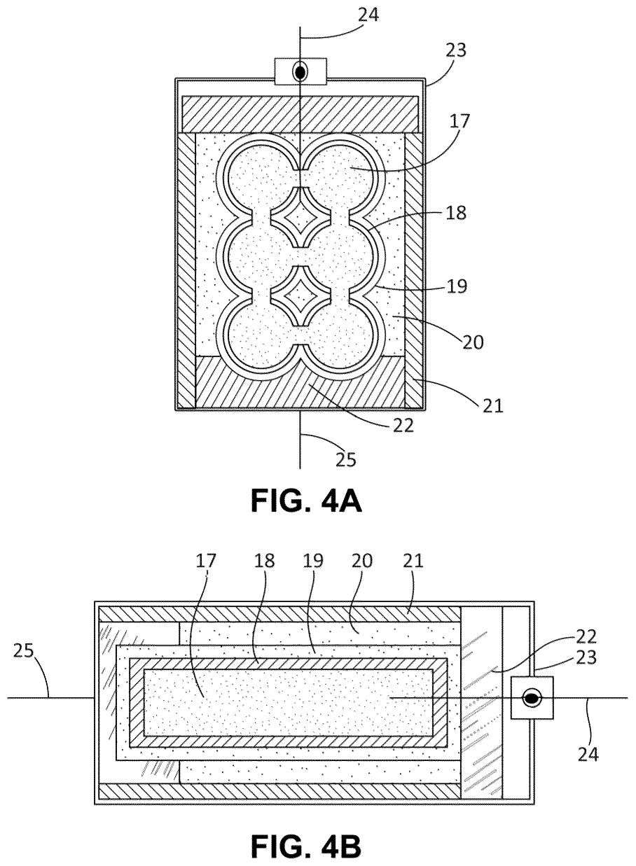

In FIGS. 4A-4B, like numbers refer to the same components. With reference to inventive FIGS. 4A and 4B, inventive Hybrid Polymer-Wet Tantalum (Ta) capacitors include the following components: (i) a hermetic can 23 with a glass insulator which houses the capacitator; (ii) a Ta anode 17, which is made from Ta particles pressed and sintered together in a vacuum to form a porous Ta Anode; (iii) attached (pressed in or welded) to the Ta anode is a Ta wire which leads to a positive termination 24 external to the Ta anode. The Ta anode is porous as a result of the Ta metal particles being compressed and sintered together. On the surfaces of the tantalum particles, including the outer surfaces and inner porous surfaces, resides a tantalum oxide dielectric 18 (tantalum pentoxide), which has been electrochemically formed thereon. A conductive polymer covering 19 resides on (over) the oxide dielectric 18, including inside and outside of the porous tantalum anode 17. A liquid electrolyte 20 made from, for example, water-diluted sulfuric acid or organic liquids such as polyethylene glycol (PEG), surrounds the conductive polymer. The liquid electrolyte is contained in the housing of a hermetic can with glass insulator 23. The cathode 21 is connected to the metal housing and made of a thin sleeve of sintered fine Ta powder or can comprise ruthenium oxide (RnO2). The Ta anode with the oxide dielectric and conductive polymer is contained by the top and bottom plastic holders 22 (or alternatively cloth separators) . The hermetic housing can 23 with a glass insulator may be made of tantalum or a metal alloy such as brass. A positive termination 24 that extends from the glass insulator in the hermetic can housing is welded to the Ta wire attached to the Ta anode. A negative termination 25 welded to the metal can housing may extend from the opposite end of the capacitor housing.

Contrary to prior art conventional capacitors, the inventive capacitors are designed to overcome the disadvantages of both Wet and Polymer Ta capacitors by using a conductive polymer in combination with liquid electrolyte to produce Hybrid Polymer-Wet Ta capacitors with BDVs and DC leakage approaching the BDVs and DC leakage of Wet Ta capacitors, and ESRs and capacitance stability over temperature and frequency approaching the ESRs and capacitance stability of Polymer Tantalum capacitors.

In one aspect of the invention there is provided a method of making a tantalum capacitor which includes the steps of:
(a) providing a Ta anode formed by compressing and sintering tantalum powder into a porous tantalum anode with pressed-in or welded tantalum wire wherein said tantalum anode comprises no more than 0.1 ppm/uC/g (parts per million/microcoulomb/gram) oxygen and no more than 0.001 ppm/uC/g carbon,
(b) anodizing said Ta anode to form a Ta oxide dielectric on the anode's surfaces wherein formation-to-rated voltage ratio is equal or below 2 V/V;
(c) dipping into or otherwise applying onto said anodized anode a slurry of conductive polymer and permitting it to dry to form a conductive polymer covering the dielectric on Ta anode;
(d) providing a liquid electrolyte in contact with said conductive polymer,
(e) providing a conductive housing to contain the cathode, liquid electrolyte, the Ta anode, dielectric and conductive polymer;
(f) forming a positive termination in electrical contact with said tantalum anode and a negative termination in electrical contact with said conductive housing.

In another aspect of the invention there is provided an electrical device comprising an anode/dielectric/conductive polymer component, said component comprising
(a) a porous Ta anode having an oxide dielectric coating;
(b) a conductive polymer formed over said dielectric, wherein the polymer is selected from intrinsically conductive polymers, such as, poly(3,4-ethyldioxythiophene), polypyrrole, polyaniline, and polythiophene; doped conductive polymers.

The Ta anode may be manufactured by methods known in the art. For example, Ta powder may be mechanically pressed to make Ta metal pellets. To improve the powder flow, organic lubricant may be added to Ta powder before pressing. The lubricant is removed after the pressing typically by heating of Ta pellets in vacuum so that organic molecules decompose and evaporate while some carbon is absorbed by Ta, increasing carbon content in Ta anodes. The pellets are subsequently sintered at high temperature under vacuum to form a porous Ta anode. At typical sintering temperatures oxygen from native oxide dissolves in Ta and increases oxygen content in Ta anodes. The sintered anode may then be anodized in a liquid electrolyte typically at elevated temperature to form a cohesive dielectric layer (Ta2O5) on the anode surface. Desirably the thus formed Ta anodes comprise no more than 0.1 ppm/uC/g oxygen and no more than 0.001 ppm/uC/g carbon. For more detail regarding the manufacturing of Ta anodes useful in the present invention, please see Y. Freeman, Tantalum and Niobium-Based Capacitors, the Second Edition, Springer, 2022, which is incorporated by reference in its entirety. This book also presents advanced technologies such as aquas de-lubrication and magnesium de-oxidation that provide low carbon and oxygen contents in the sintered Ta anodes.

In another aspect of the invention there is a tantalum capacitor which includes:
(a) a metallic case housing;
(b) a porous tantalum anode, desirably having no more than 0.1 ppm/uC/g oxygen and no more than 0.001 ppm/uC/g carbon;
(c) a layer of tantalum oxide dielectric on the inner and outer surfaces of said tantalum anode;
(d) a conductive polymer covering the dielectric layer, desirably formed by immersing, dipping or otherwise depositing the polymer from a polymer slurry;
(e) a liquid electrolyte substantially surrounding said conductive polymer;
(f) a cathode, which is connected to the metallic case housing and made of a thin sleeve of sintered fine Ta powder covered with thin Ta oxide or can comprise ruthenium oxide (RnO2);
(g) a first termination in electrical contact with the tantalum anode through a Ta wire; and
(h) a second termination in electrical contact with the metallic case housing, cathode and liquid electrolyte, which in turn is in connection with the conductive polymer.

The details of the materials, components and process steps discussed herein apply to each of the different aspects and embodiments of the inventive capacitors.

The metallic housing may be selected from a variety of materials such as tantalum or metal alloy like brass. Its primary purpose is to protect the capacitor from the outside environment and to provide long-term durability. The housing is hermetically sealed to isolate the components from the external environment and to keep the electrolyte from leaking.

The conductive polymer may be formed of a variety of pre-polymerized conductive polymers, using the slurry polymer method, whereby an aqueous or solvent-based slurry of the polymer is formed and the anodized anode is immersed in the slurry, followed by drying of liquid (water or solvent) to deposit a coating of the conductive polymer on the oxide dielectric. Desirably the intrinsically conductive dopped polymers are selected from the group consisting of poly(3,4-ethyldioxythiophene), polypyrrole, polyaniline, and polythiophene, and combinations thereof, although this list is non-limiting. Most often, the polymer cathode is made of poly(3,4-ethyldioxythiophene) (PEDOT) dopped with poly(styrene sulfonate) (PSS).

A non-limiting list of useful liquid electrolytes includes aqueous sulfuric acid or boric acid solutions or organic liquids such as polyethylene glycol (PEG), and combinations of these liquids.

### Example

Wet Electrolytic and Hybrid Polymer-Wet Tantalum (Ta) capacitors 82 uF-75 V were manufactured. The Ta anodes were manufactured by pressing and sintering of Ta powder with specific charge 18,000 uC/g (microcoulomb/gram) and Ta wire was welded to the tantalum anodes in inert atmosphere. The deoxidation by magnesium and aqueous de-lubrication were included in the anode manufacturing providing low oxygen 0.05 ppm/uC/g and carbon 0.0004 ppm/uC/g contents in Ta anodes. The formation of the Ta oxide dielectric on the Ta anodes was performed in diluted phosphoric acid at formation voltage 135 V, which provided a formation voltage (FV) to working voltage (WV) ratio FV/WV=1.8 V/V. The conducting polymer over the dielectric in Hybrid Polymer-Wet Ta capacitors was produced by dipping of the formed Ta anodes into a waterborne dispersion (slurry) of the nanoscale poly(3,4-ethylenedioxythiophene) (PEDOT) particles with the dopant poly(styrene sulfonate) (PSS). The Ta anodes were subsequently dried in air at room temperature and then at about 150° C. These processes provided coverage of the oxide dielectric with conducting polymer inside and outside of the porous Ta anodes in Hybrid Polymer-Wet Ta capacitors. The finishing process was the same for the Wet and Hybrid Polymer-Wet Ta capacitors. These processes included welding of the nickel wire to the Ta wire as positive termination, assembly of the anode/dielectric and anode/dielectric/polymer units in the Ta cans with cathode and negative termination, filling the cans with diluted sulfuric acid liquid electrolyte, and hermitization of the Ta cans.

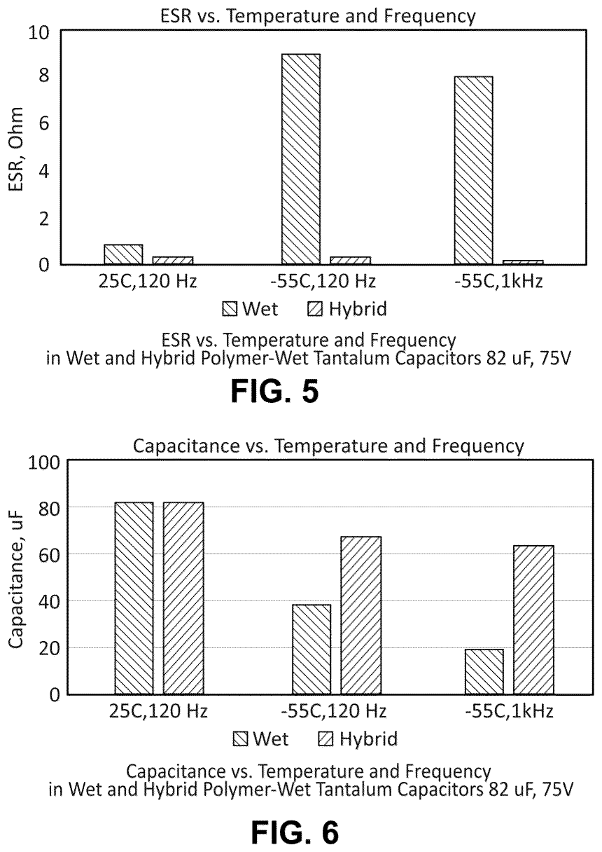

The end-of-line electrical test of the Wet and Hybrid Polymer-Wet Ta capacitors at room temperature showed similar dc leakage current at rated voltage and similar capacitance at 120 Hz. At the same time, ESR in Hybrid Polymer-Wet Ta capacitors was lower than ESR in Wet Ta capacitors and the difference in ESR between these capacitors increased sharply at lower temperature (FIG. 5).

The Hybrid Polymer-Wet Ta capacitors also showed higher capacitance stability with temperature and frequency in comparison to these in Wet Ta capacitors (FIG. 6).

According to FIGS. 5 and 6, Hybrid Polymer-Wet Ta capacitors have lower ESR, especially at low temperature, and higher capacitance stability with temperature and frequency in comparison to Wet Ta capacitors. These advantages of Hybrid Polymer-Wet Ta capacitors vs. Wet Ta capacitors were achieved due to the conductive polymer coverage of the oxide dielectric in tiny pores in Ta anodes that are major contributors to the ESR. Lower ESR allows higher ripple current in Hybrid Polymer-Wet Ta capacitors.

In comparison to Polymer Ta capacitors, Hybrid Polymer-Wet Ta capacitors have lower dc leakage comparable to the dc leakage in Wet Ta capacitors. The lower dc leakage was observed with reduced formation-to-rated voltage ratio and thus thinner dielectric in Hybrid Polymer-Wet Ta capacitors vs. the dielectric thickness in Polymer Ta capacitors. The thinner dielectric in Hybrid Polymer-Wet Ta capacitors resulted in increased charge efficiency CV/cc, smaller size anode and related cost reduction. Reducing the dielectric thickness while maintaining low DCL in Hybrid Polymer-Wet Ta capacitors was also beneficial for the long-term stability and reliability of these capacitors. The thinner dielectrics are less prone to crystallization of their amorphous matrix, which is a major reason for the degradation and catastrophic failures of high voltage Ta capacitors [See Y. Freeman, Tantalum and Niobium-based Capacitors, the 2nd Edition, Springer, 2022].

The foregoing illustrates some of the possibilities for practicing the invention.

Therefore, although specific example embodiments have been described, it will be evident that various modifications and changes may be made to these embodiments without departing from the broader scope of the invention; many other embodiments are possible within the scope and spirit of the invention. Various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the above Description of the invention, with each claim standing on its own as a separate example embodiment.

1. A method of forming a hybrid Polymer-Wet Tantalum capacitor comprising:
(a) providing a Ta anode formed by compressing and sintering of tantalum powder into a porous tantalum anode and having tantalum wire welded or pressed into the anode;
(b) anodizing said Ta anode to form a Ta oxide dielectric on the anode's surfaces;
(c) dipping into or otherwise applying onto said anodized anode a slurry of conductive polymer and permitting it to dry to form a conductive polymer covering the dielectric inside and outside the porous Ta anode;
(d) providing a liquid electrolyte in contact with said conductive polymer,
(e) providing a conductive housing to contain the cathode, liquid electrolyte and the Ta anode with the oxide dielectric and conductive polymer; and
(f) forming a positive termination in electrical contact with said tantalum anode and a negative termination in electrical contact with said conductive housing.

2. The method of claim 1, wherein said tantalum anode comprises no more than 0.1 ppm/uC/g oxygen and no more than 0.001 ppm/uC/g carbon.

3. The method of claim 1, wherein the tantalum oxide dielectric is formed with a formation-to-rated voltage ratio equal to or below 2.

4. The method of claim 1, wherein the liquid electrolyte is selected from the group consisting of aqueous sulfuric acid solution, aqueous boric acid solution, organic liquids and combinations thereof.

5. The method of claim 1, wherein the liquid electrolyte comprises polyethylene glycol (PEG).

6. The method of claim 1, wherein the conductive polymer is selected from the group consisting of poly(3,4-ethyldioxythiophene), polypyrrole, polyaniline, and polythiophene and combinations thereof.

7. The method of claim 1, wherein the housing is of metal selected from the group consisting of tantalum or a metal alloy such as brass.

8. The method of claim 1, wherein the cathode is connected to the metallic housing and comprises a thin sleeve of sintered fine Ta powder or may comprise ruthenium oxide (RnO2).

9. The method of claim 1, wherein the hybrid capacitor has higher voltage, lower DC leakage and higher charge and energy efficiency in comparison to Polymer Tantalum capacitors and lower ESR, higher ripple current, and higher capacitance stability over temperature and frequency in comparison to Wet Tantalum capacitors.

10. A Hybrid Polymer-Wet Tantalum capacitor, comprising:
(a) a metallic case housing;
(b) a porous tantalum anode, desirably having no more than 0.1 ppm/uC/g oxygen and no more than 0.001 ppm/uC/g carbon;
(c) a layer of tantalum oxide on the inner and outer surfaces of said tantalum anode;
(d) a conductive polymer covering the dielectric layer, desirably formed from by immersing, dipping or otherwise depositing the polymer from a polymer slurry;
(e) a liquid electrolyte substantially surrounding said conductive polymer;
(f) metallic housing with cathode;
(g) a first termination in electrical contact with the tantalum anode through a Ta wire; and
(h) a second termination in electrical contact with the metal housing, cathode and liquid electrolyte, which in turn is in connection with the conductive polymer.

11. The hybrid capacitor of claim 10, wherein said tantalum anode comprises no more than about 0.1 ppm/uC/g oxygen and no more than about 0.001 ppm/uC/g carbon.

12. The hybrid capacitor of claim 10, wherein said tantalum oxide dielectric is formed with a formation-to-rated voltage ratio equal to or below 2 V/V.

13. The hybrid capacitor of claim 10, wherein the liquid electrolyte is selected from the group consisting of aqueous sulfuric acid solution, aqueous boric acid solution, organic liquids and combinations thereof.

14. The hybrid capacitor of claim 10, wherein the liquid electrolyte comprises polyethylene glycol (PEG).

15. The hybrid capacitor of claim 10, wherein the conductive polymer is selected from the group consisting of poly(3,4-ethyldioxythiophene), polypyrrole, polyaniline, and polythiophene and combinations thereof.

16. The hybrid capacitor of claim 10, wherein the housing is of metal selected from the group consisting of tantalum or metal alloy like brass.

17. The hybrid capacitor of claim 10, wherein the capacitor has higher breakdown voltage, lower dc leakage and higher charge and energy efficiency in comparison to Polymer Tantalum capacitors and lower ESR, higher ripple current, and higher capacitance stability over temperature and frequency in comparison to Wet Tantalum capacitors.

18. An electrical device comprising an anode/dielectric/conductive polymer component (unit), said component comprising:
(a) a porous Ta anode having an oxide dielectric coating;
(b) a conductive polymer formed over said dielectric comprising a dopped conductive polymer, wherein the polymer is selected from dopped intrinsically conductive polymers consisting of poly(3,4-ethyldioxythiophene), polypyrrole, polyaniline, and polythiophene.
